(19) United States
(12) Patent Application Publication
(10) Pub. No.: US 2016/0072912 A1
(43) Pub. Date: Mar. 10, 2016

(54) APPARATUS FOR USER CHALLENGE GENERATION FOR COMPETITIVE COLLABORATION

(71) Applicant: Harsha Vaman Shanbhag, Portland, OR (US)

(72) Inventor: Harsha Vaman Shanbhag, Portland, OR (US)

(21) Appl. No.: 14/477,067

(22) Filed: Sep. 4, 2014

(51) Int. Cl. H04L 29/08; G06F 3/0481

(52) U.S. Cl. CPC H04L 67/306; G06F 3/04815

(57) ABSTRACT

Apparatuses, methods and storage media for user challenge generation are described. In one instance, an apparatus may include an integrated circuit; and logic to be operated by the integrated circuit to: select a polyhedron having a number of vertices that substantially corresponds to a number of users having user-associated information that includes first and a true statement and false statements; associate each edge of the polyhedron with a character; select a face of the polyhedron for a provision of a secret code comprising a sequence of characters associated with edges of the selected face; associate user information with vertices; and generate challenges for the users based on the above actions. The challenges include suggestions for the characters comprising the secret code, e.g., those characters that are associated with edges, which correspond with true statements and false statements. Other embodiments may be described and claimed.

### CROSS REFERENCE TO RELATED APPLICATION

The present application claims priority from the Provisional Application No. 61/874,371 entitled “Competitive Collaboration Activity Involving Multiple Participants,” filed Sep. 6, 2013.

### TECHNICAL FIELD

The present disclosure relates to the field of applied computing, in particular, to apparatuses, methods and storage media associated with leveraging computing technology to facilitate competitive collaboration via user challenge generation and provision.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Often times in social gatherings; e.g., online in social forums, or offline, participants tend to socialize in clusters based on their common interests. Activities motivating each user (participant) to interact with everyone else may exist in various forms. However, the popularity of such activities may depend on different attributes (which are not always present in social environment), such as motivating the users to be competitive, encouraging users to form collaborations with other users (e.g., competitors), and/or encouraging users to employ a mix of intelligence, gut-feeling, good pacing, and rely on some element of luck. Accordingly, only a few of the participants (e.g., online forum users) may be motivated to go out of their way to connect with other participants, which may leave the rest unable to leverage their full potential and leave organizers short of tapping the participants' full potential.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram illustrating an example system configured to facilitate competitive collaboration, in accordance with various embodiments.

FIGS. 2-7 illustrate an example implementation of user challenge generation, in accordance with some embodiments.

FIGS. 8-9 illustrate an example process for user challenge generation, in accordance with some embodiments.

FIG. 10 illustrates an example computing device suitable for use to practice all or selected aspects of the present disclosure, in accordance with various embodiments.

FIG. 11 illustrates an example computer-readable storage medium having instructions configured to cause a computing device to practice all or selected aspects of the present disclosure, in accordance with various embodiments.

FIG. 12 is an example computing environment suitable for practicing all or selected aspects of the present disclosure, in accordance with some embodiments

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Computing apparatuses, methods and storage media associated with user challenge generation are described herein. In one instance, an apparatus may include an integrated circuit and logic to be endowed in or operated by the integrated circuit. The logic may be configured to select a polyhedron having a number of vertices that substantially corresponds to a number of users. The number of users may comprise at least first and second users, having first and second user-associated information, wherein the first and second user information includes respectively first and second true statements and at least first and second false statements. The logic may be further configured to associate each edge of the polyhedron with a character of a set of characters and select a face of the polyhedron for a provision of a secret code. The secret code may comprise a sequence of characters associated with edges of the selected face, wherein the order of the characters in a code may correspond to a direction of a loop around the selected face.

The logic may be further configured to associate the first user information with a first vertex and the second user information with a second vertex, which may include association of the first and second true statements with first and second edges that correspond to shortest paths from the first and second vertices to the selected face, and association of the first and second false statements with at least some of remaining edges connecting the first and second vertices respectively to neighboring vertices. The logic may be further configured to generate first and second challenges for the first and second users. The first and second challenges may include suggestions for the characters comprising the secret code, wherein the suggestions may include those characters that are associated with edges that correspond to first and second true statements and first and second false statements.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

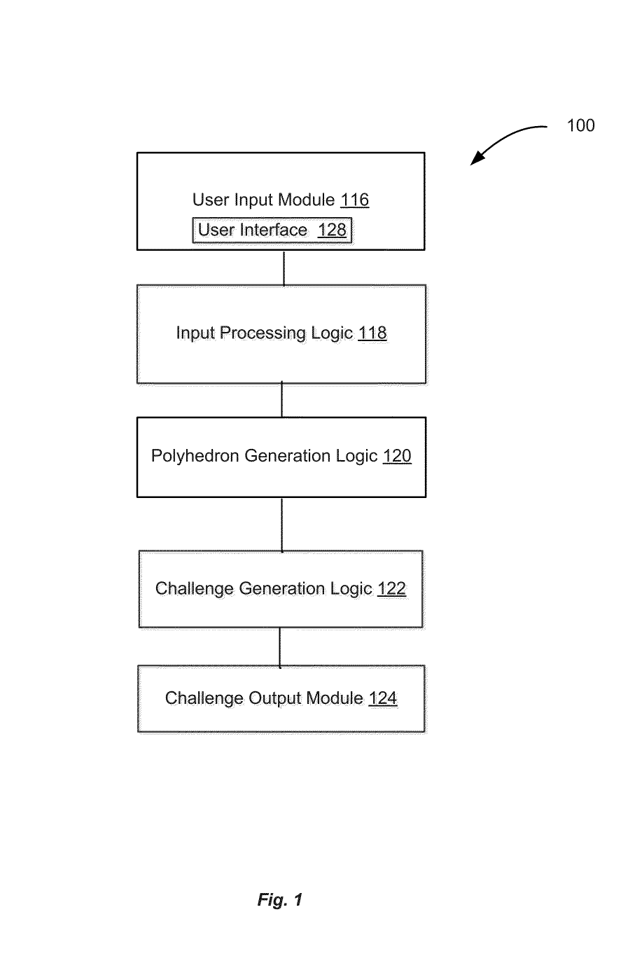

FIG. 1 is a block diagram illustrating an example system 100 configured to facilitate competitive collaboration, in accordance with various embodiments. As illustrated, the system 100 may include a plurality of logic and functional modules 116, 118, 120, 122, and 124, coupled with each other.

User input module 116 may be configured to receive user input to be used in challenge generation, e.g., via a user interface 128. For example, the user interface 128 may render fields, icons, windows, or other user interface elements on a display for information entry. Further, the user interface 128 may receive inputs entered by participant users via one or more input devices, e.g., keyboard, touchscreen, and so forth. The content of the information to be entered by participant users may include, but is not limited to, a plurality of statements (e.g., a question and plurality of answers), at least one of which may be considered a true statement, and others may comprise false statements or a combination of false and true statements. The correctness of the true statement may be as deemed by the participant user entering the statement.

The statements may comprise different types of content. For example, the content of the statements may be associated with the participant user entering the content (e.g., user personal data, such as date of birth, user views on different subjects, and the like). For example, the user may enter a number of dates of birth, one of which is presumed to be a true statement. The content that may be entered by participant users will be described below in greater detail.

In some embodiments, a number of participant users may comprise two or more users. In some embodiments, one participant user may participate in solving a secret code using user challenge techniques described herein. An electronic entity may comprise a counterpart to one user. The entity may comprise an advertisement provider, a general knowledge provider, a commercial entity, or the like. The electronic entity may supply a plurality of statements (e.g., general knowledge question and plurality of answers) to the user input module 116. These statements may be utilized as content provided by a “live” participant user as described below in greater detail.

In some embodiments, a non-participant user may not need to provide any input, and yet may participate in solving a secret code using user challenge techniques described herein. For example, an electronic entity as described above or a different “live” user or a combination of both may comprise the set of users at least some of which may supply a plurality of statements described above to the user input module 116. For example, the electronic entity may supply the statements, adding to the statements supplied by “live” user or users, or providing a set of pluralities of statements that may be sufficient to engage a participant user (or multiple users) in solving the secret code.

Input processing logic 118 may be coupled with the user input module 116 and configured to process user-input information as described in reference to user input module 116. In some embodiments, input processing logic 118 may be configured to associate the input information (e.g., with user unique identifier, such as name, nick name, or the like), aggregated user-input information from participant users and store the user-input information for further processing as described below.

Polyhedron generation logic 120 may be coupled with the input processing logic 118 and configured to select an n-polytope (e.g., polyhedron) type based on the aggregated user-input information. More specifically, the polyhedron generation logic 120 may select an n-polytope (e.g., polyhedron) with number of vertices more than or equal to the number of participant users. One skilled in the art will appreciate that the term “n-polytope” may comprise any high dimensional object, such as a polyhedron. For simplicity purposes, the term “polyhedron” will be used hereinafter, with understanding that the embodiments described herein are not limited to using a polyhedron. Any type of n-polytope may be utilized in the embodiments described herein.

The polyhedron may not necessarily comprise the smallest size (e.g. have the smallest number of vertices that is equal or greater than a number of participant users), but it may be advisable to select such a polyhedron for simplicity purposes.

Polyhedron generation logic 120 may be further configured to associate each edge of the selected polyhedron with a randomly generated unique identifier, such as a letter of alphabet. Polyhedron generation logic 120 may be further configured to select (e.g., in a random fashion) a face of the polyhedron. Polyhedron generation logic 120 may be further configured to select (e.g., in a random fashion) a direction of looping the selected face.

In some embodiments, polyhedron generation logic 120 may be configured to select (e.g., in a random fashion) an edge on the face as the starting point for a secret code that may comprise a combination, such as sequence, of edge unique identifiers (e.g., letters) corresponding to edges of the selected face, if looped in the randomly chosen direction until the starting edge is reached. In some embodiments, a starting point may not be selected, and the secret code may comprise a combination of edge unique identifiers (letters) corresponding to the edges of the selected face, if looped in the randomly chosen direction from any starting point (e.g., also randomly chosen), until that starting point is reached.

Polyhedron generation logic 120 may be configured to map (e.g., associate) each participant user to a vertex of the selected polyhedron. For example, user-input information for each user may be associated with a vertex of the polyhedron. The association may be done in a random fashion.

Polyhedron generation logic 120 may be further configured to fill in the difference in the number of vertices in the selected polyhedron and the number of participant users, with randomly generated entities. For example, if the number of users is six, the smallest polyhedron that may be selected may be a cube having eight vertices. Accordingly, two vertices may need to be associated with entities that may not be participant users, but that may provide associated information similar to the user-input information, e.g. a combination of a true statement and one or more false statements. These randomly generate entities may be a sponsoring entity that may contribute a pre-contributed advertisement question and corresponding answers (one of which may be a correct answer, e.g., true statement), or a general knowledge entity, which may contribute a general knowledge question with a set of corresponding answers (true and false), or any other entity not necessarily limited to the aforementioned entities.

Accordingly, each vertex of the polyhedron may be associated with user-input information or fill-in information associated with randomly generated entity. Polyhedron generation logic 120 may be further configured to select a vertex from the polyhedron vertices. Polyhedron generation logic 120 may be further configured to identify a neighboring vertex that may lie on a shortest path from the selected vertex to the selected face that corresponds to the secret code. In some embodiments, polyhedron generation logic 120 may select an edge that may comprise (e.g., lie on) the shortest path from the selected vertex to the selected face.

Polyhedron generation logic 120 may associate a true statement of the user-input information associated with the selected vertex (e.g., a correct answer to the question) to the edge comprising at least a portion of the shortest past to the selected face. Other statements (e.g., false statements such as wrong answers to the question) may be associated with each edge connecting all the other neighboring vertices with the selected vertex. If a neighboring vertex belongs to (lies on) the selected face that corresponds to the secret code, the true statement (e.g., correct answer to the question) may be associated with the edge leading to the next vertex in the selected direction of looping the selected face as described above.

It is known that the number of edges extending from a vertex of a polyhedron may not exceed six. Accordingly, the total number of statements in the user-input information may not need to exceed six.

Challenge generation logic 122 may be coupled with the polyhedron generation logic 120 and configured to provide a challenge to participant users. More specifically, challenge generation logic 122 may be configured to generate a set of statements for each vertex. For each question, challenge generation logic 122 may offer a set of choices (e.g., answer choices) equal to the number of neighboring vertices on the polyhedron, for example, in random order. For example, each choice may be associated with one of the answers provided by the participant user (or randomly-generated entity) associated with the vertex. For each answer, the challenge generation logic 122 may provide a unique identifier (e.g., letter) corresponding to the edge associated with the answer and a recommendation on the next question to solve. For example, challenge generation logic 122 may provide a recommendation to contact a participant user corresponding to a neighboring vertex.

Challenge output module 124 may be coupled with challenge generation logic 120 and configured to present a participant user with the information generated by the challenge generation logic 122, challenging the users to find the secret code. In some embodiments, challenge output may offer incentives for the first few users who successfully identified a secret code.

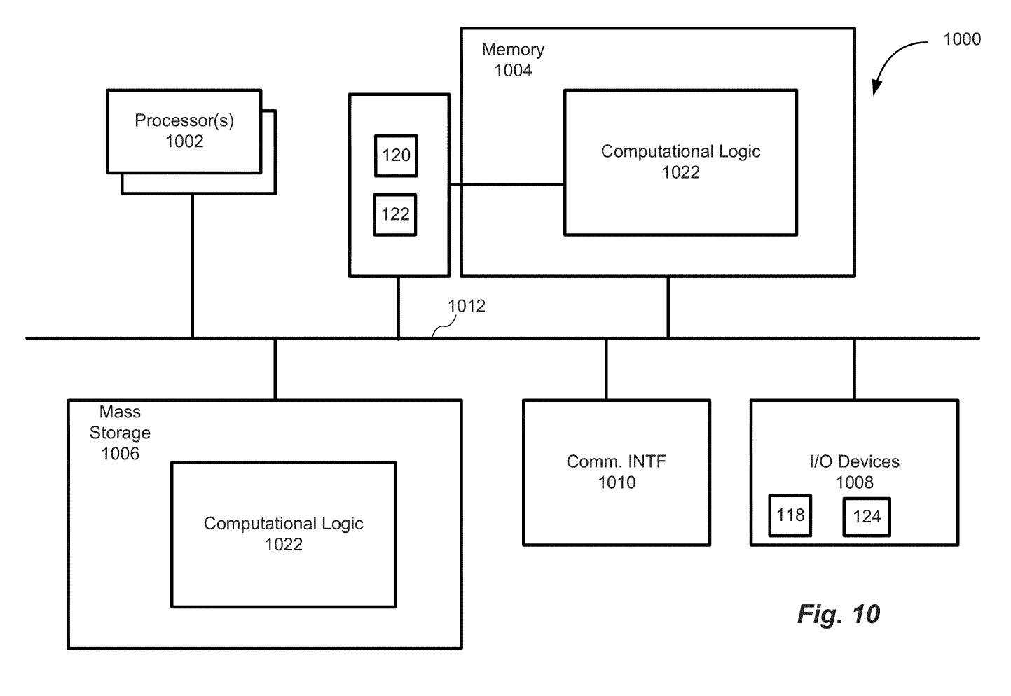

In some embodiments, one or more of the illustrative components may be incorporated in, or otherwise form a portion of, another component. For example, logic and functional modules 116, 118, 120, 122, and 124, or portions thereof, may be incorporated memory 114 and be executable on one or more processors. Logic and functional modules 116, 118, 120, 122, and 124 may be implemented as software, hardware, or a combination thereof. In some embodiments, some or all of the functionalities of the computer system 100, such as processing power, memory capacity, and provision and execution of logic and functional modules 116, 118, 120, 122, and 124 may be distributed among one or more computing devices comprising the computer system 100. In some embodiments, logic and functional modules 116, 118, 120, 122, and 124 of the computing system 100 may be associated with a computing device, forming a special purpose computing device. The embodiments of computer system 100 will be described in greater detail in reference to FIGS. 10-12.

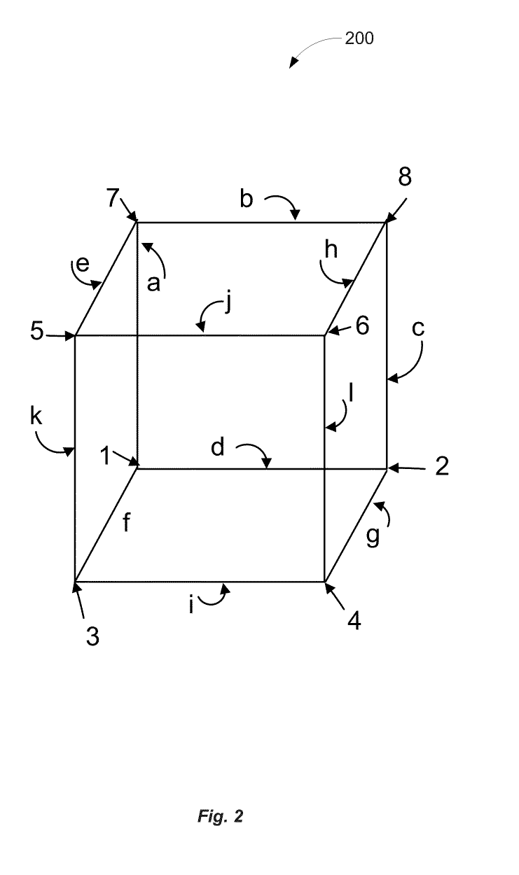

FIGS. 2-7 illustrate an example implementation of user challenge generation, in accordance with some embodiments. One skilled in the art will appreciate that the examples described in reference to FIGS. 2-7 are simplified, and used for illustrative purposes only and are not intended to limit the embodiments described herein. In practice, the implementation may be more complex involving polyhedron of many dimensions that cannot be illustrated in a 2D figure in a comprehensible manner. The simplified example of user challenge generation of FIGS. 2-7 is provided to enable understanding of the operation of the system 100 described in reference to FIG. 1.

For the purposes of example implementation of FIGS. 2-7, one may assume there is a group of participant users (e.g., six users) to participate in challenge solving, where each user may not necessarily know any other. As described above, user input module 116 may receive from each participant user user-input information, such as a question with a true statement (correct answer) and one or more (e.g., two) false statements (wrong answers). Table 1 below shows the list of questions and their corresponding set of answers from each user. Each question may be contributed by each user. User-input information provided by each user may include the name of the participant user, the question provided by the participant user, and a set of answers to the question. The answers may include the correct answer and a set of wrong answers. The correctness or incorrectness of each answer may be from the point of view of the contributing user and may be considered accordingly.

TABLE 1

1) Jack
Question: What is the name of my highschool?
Correct answer: West View High School
Wrong answer: SunSet High School
Wrong answer: SunRise High School
2) Jane
Question: What is my favorite number?
Correct answer: 201
Wrong answer: 101
Wrong answer: 301
3) Mitch
Question: What is going on in my mind right now?
Correct answer: feel like tricking you
Wrong answer: feel like singing loudly
Wrong answer: fell like yelling at you
4) Deepak
Question: Whom do I work for?
Correct: CIA
Wrong: RAW
Wrong: KGB
5) Tiger
Question: I currently think God is ?
Correct: great
Wrong: non-existent
Wrong: me
6) Yi Ling
Question: What is my paternal
Granddad's granddad's name?
Correct: Xie Chen
Wrong: Xiao Chao
Wrong: Yi Zhang

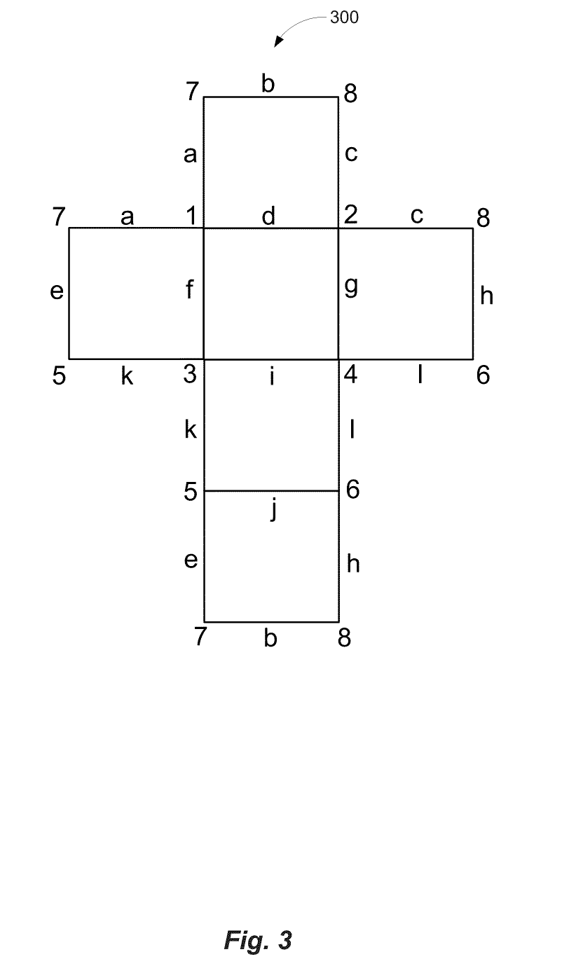

Polyhedron generation logic 120 may select the smallest polyhedron large enough to accommodate the six participants. As briefly described above, such polyhedron may comprise a cube. FIG. 2 illustrates the selected cube 200. FIG. 3 illustrates the same cube 300 unfolded as seen in two dimensions. As seen in FIGS. 2-3, the selected cube has eight vertices, but there are six participant users, as seen in Table 1. Hence, polyhedron generation logic 120 may fill in the difference with two general knowledge questions as seen in table 2. Question 7 introduces a general knowledge question along with one correct and two wrong answers. Question 8 introduces a question that promotes a shoe brand from Nike®. This question comes with a correct answer and incorrect answers.

TABLE 2

7) Barack Obama
Question: My date of birth is?
Correct: August 4^{th}
Wrong: September 4^{th}
Wrong: November 4th
8) Nike ®
Question: Jordon Shoe provides the most
performant fit for which sports?
Correct: Basketball
Wrong: Golf
Wrong: Baseball

As described above, polyhedron generation logic 120 may assign unique identifiers (e.g., may number) each vertex and associate a unique letter of alphabet to each edge of the cube, as shown in FIGS. 2 and 3. As illustrated, the vertices of the cube 200 (300) are numbered 1 to 8, and the edges of the cube are named ‘a’ to ‘l’.

Vertex 1, which is on the deeper bottom-left end of the cube, is connected to vertex 7, which is on the deeper top-left end; vertex 3, which on the front bottom-left end; and vertex 2, which is on the deeper bottom-right end of the cube 200. Vertex 6, which is on the front top-right end of the cube 200, is connected to vertex 8, which is on the deeper top-right; vertex 5, which is on the front top-left end; and vertex 4, which is on the front bottom-right end of the cube 200. Similarly, vertex 8 is connected to vertex 7, vertex 6 and vertex 2. Vertex 4 is connected to vertex 2, vertex 3 and vertex 6. Vertex 3 is connected to vertex 1, vertex 5 and vertex 4. Vertex 2 is connected to vertex 8, vertex 1 and vertex 4. Vertex 7 is connected to vertex 8, vertex 5 and vertex 1. Vertex 5 is connected to vertex 6, vertex 3 and vertex 7.

Further, as shown in FIGS. 2 and 3, edge ‘d’ connects vertex 1 to vertex 2. Edge ‘f’ connects vertex 1 to vertex 3. Edge ‘i’ connects vertex 3 to vertex 4. Edge ‘g’ connects vertex 4 to vertex 2. Edge ‘j’ connects vertex 5 to vertex 6. Edge ‘b’ connects vertex 7 to vertex 8. Edge ‘e’ connects vertex 7 to vertex 5. Edge ‘h’ connects vertex 6 to vertex 8. Edge ‘k’ connects vertex 5 to vertex 3. Edge ‘1’ connects vertex 6 to vertex 4. Edge ‘a’ connects vertex 7 to vertex 1. Edge ‘c’ connects vertex 8 to vertex 2.

As described above, polyhedron generation logic 120 may select a random face of the cube 200 (300). In some embodiments, polyhedron generation logic 120 may select a random vertex on the selected face of the cube as the starting point.

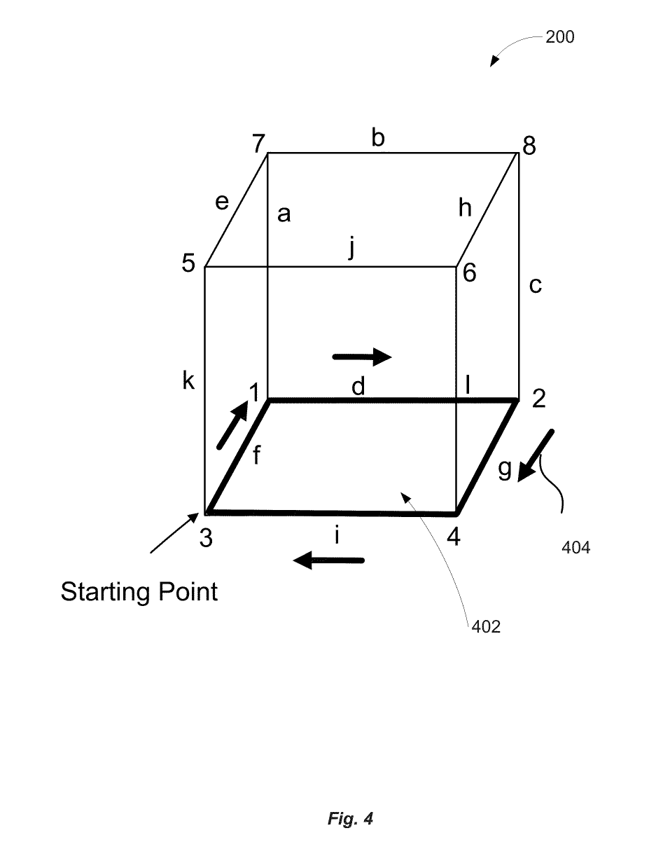

FIG. 4 illustrates cube 200 with a face 402 selected by polyhedron generation logic 120. Face 402 may be randomly selected and may comprise vertex 1, vertex 2, vertex 4 and vertex 3. The starting point of the loop may be randomly chosen as vertex 3. Arrow 404 shows the direction of the loop, which may also be randomly selected. As shown, the loop may start at vertex 3, continue to vertex 1, vertex 2, and vertex 4. Accordingly, the secret code corresponding to that loop is ‘fdgi’. The first letter of the secret-code is ‘f’, which corresponds to the first edge of the loop. The second letter of the secret-code is letter ‘d’ which corresponds to the second edge of the loop. The third letter of the secret-code is ‘g’, which corresponds to the third edge of the loop. The fourth letter of the secret-code is ‘i’, which corresponds to the last edge of the loop.

In some embodiments, the starting point may not be selected. In these embodiments, the secret code may comprise any sequential circular combination of letters assembled in the direction 404. For example, the secret code may be any of ‘fdgi’, ‘dgif’, ‘gifd’, or ‘ifdg’. In other words, any sequential circular combination of the letters corresponding to the edges of the selected face 402 may be considered a secret code, if guessed correctly.

Polyhedron generation logic 120 may randomly map (associate) each question to a vertex of the cube, as shown in Table 3. More specifically, Table 3 shows the random mapping of each question corresponding to a user (Table 1) or the general-knowledge/sponsored question (Table 2) to a corresponding vertex. Thus, question 1 maps to vertex 7, question 2 maps to vertex 3, question 3 maps to vertex 4, question 4 maps to vertex 1, question 5 maps to vertex 6, question 6 maps to vertex 8, question 7 maps to vertex 2, and question 8 maps to vertex 5.

TABLE 3

Question 1 (User 1) → vertex 7
Question 2 (User 2) → vertex 3
Question 3 (User 3) → vertex 4
Question 4 (User 4) → vertex 1
Question 5 (User 5) → vertex 6
Question 6 (User 6) → vertex 8
Question 7 (User 7) → vertex 2
Question 8 (User 8) → vertex 5

As described in reference to FIG. 1, polyhedron generation logic 120 may find the vertex lying on the shortest path from each vertex of the cube to the selected face and associate the correct answer to the corresponding edge. Polyhedron generation logic 120 may associate the wrong answers to the remaining edges emanating from the same vertex.

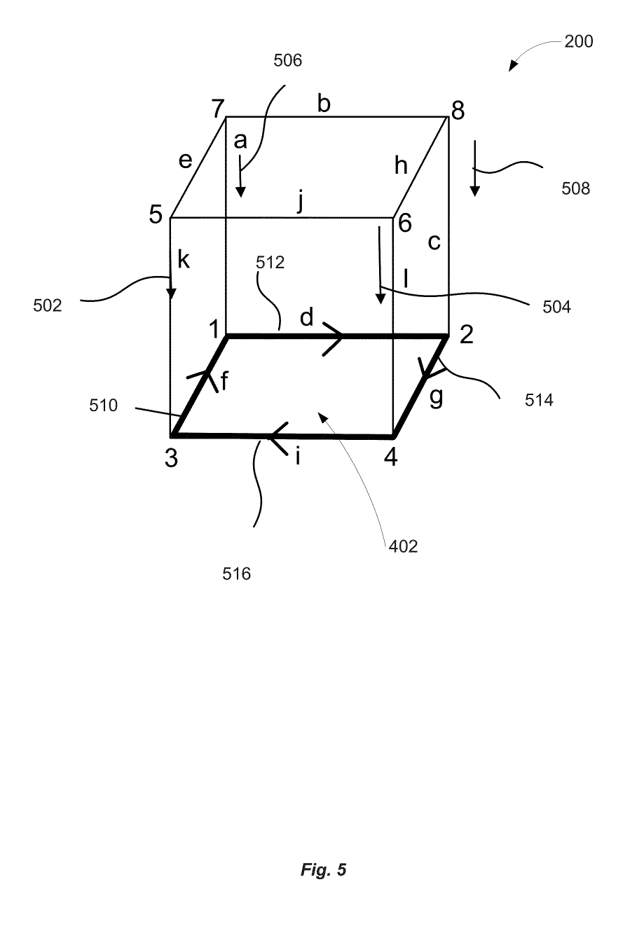

FIG. 5 shows the neighboring vertices on the shortest path to face 402 for each vertex in the cube 200. For vertex 5, vertex 3 is on the shortest path to face 402 as shown by arrow 502. For vertex 6, vertex 4 is on the shortest path to face 402 as shown by arrow 504. For vertex 7, vertex 1 is on the shortest path to face 402 as shown by the arrow 506. For vertex 8, vertex 2 is on the shortest path to face 402 as shown by the arrow 508. For vertex 3, vertex 1 is the next element on face 402 in the selected direction and hence on the shortest path as shown the arrow 510. For vertex 1, vertex 2 is the next element on face 402 in the selected direction and hence on the shortest path as shown by arrow 512. For vertex 2, vertex 4 is the next element on face 402 in the selected direction and hence on the shortest path as seen by the arrow 514. For vertex 4, vertex 3 is the next element on face 402 in the selected direction and hence on the shortest path as seen by the arrow 516.

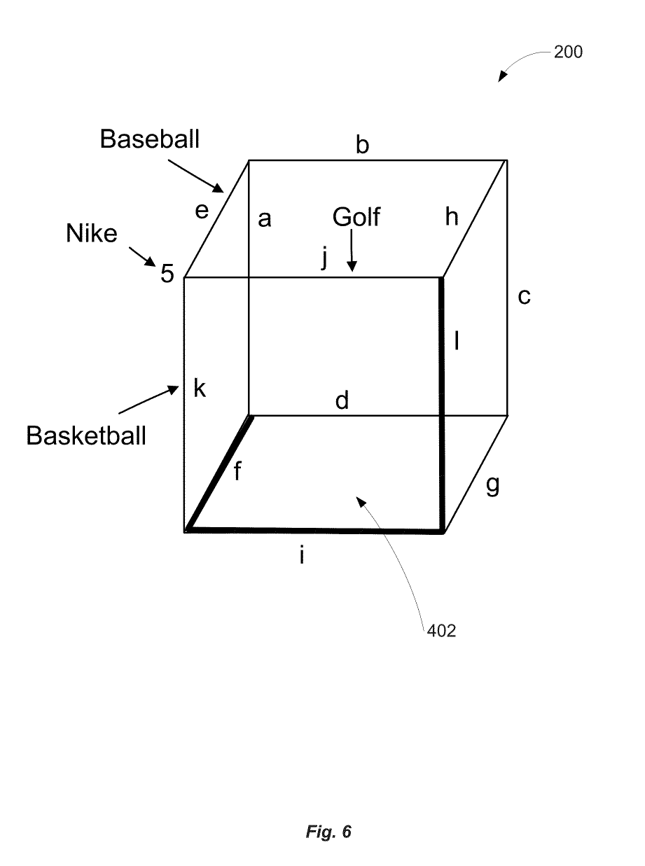

FIG. 6 shows the association of the correct answer and wrong answers to the edges emanating from one such vertex, vertex 5 of the cube 200, in accordance with some embodiments. The question corresponding to Nike® is associated with vertex 5 as—shown in Table 3. The correct answer ‘basketball’ is associated with edge ‘k’, which is on the shortest path to selected face 402. The wrong answer ‘golf’ is associated with edge ‘j’, which is not on the shortest path from vertex 5 to face 402. The wrong answer ‘baseball’ is associated with edge ‘e’, which is not on the shortest path from vertex 5 to face 402.

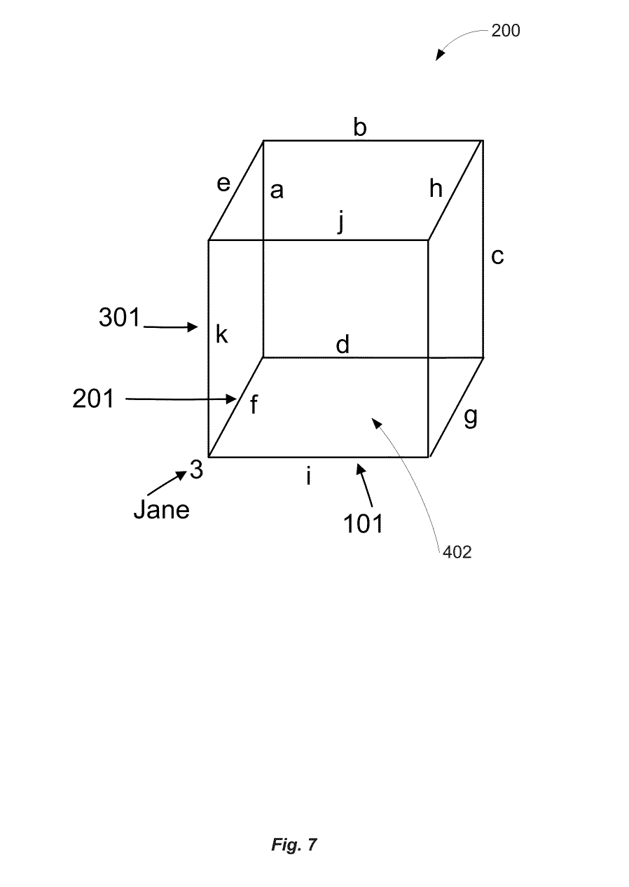

FIG. 7 shows the association of the correct answer and wrong answers to the edges emanating from vertex 3 of the cube 200. The question corresponding to Jane is associated with vertex 3 as discussed in reference to FIG. 2. The correct answer ‘201’ is associated with the edge ‘f’ which leads to the next vertex on the face 402. The wrong answer ‘101’ is associated with the edge ‘i’ which does not lead to the next vertex on the face 402. The wrong answer ‘301’ is associated with the edge ‘k’ which leads away from the face 402 and hence does not lead to the next vertex on the face 402.

As described in reference to FIG. 1, challenge generation logic 122 may collect the associations resulting from the actions performed by polyhedron generation logic 120 and generate the user challenge as seen in Table 4.

TABLE 4
(1) Deepak
Whom do I work for?

| | | | |
|---|---|---|---|
| (a) RAW; | Goto (7) Jack: | Code | a _ _ _{—} |
| (b) CIA; | Goto (2) Obama: | Code | d _ _ _{—} |
| (c) KGB; | Goto (3) Jane: | Code: | i _ _ _{—} |

(2) Barack Obama
My birthday is?

| | | | |
|---|---|---|---|
| (a) Sept 4th, | Goto (1) Deepak | Code: | _ d _ _{—} |
| (b) Aug 4th; | Goto (4) Mitch | Code: | _ g _ _{—} |
| (c) Oct 4th, | Goto (8) Yi Ling | Code: | _ c _ _{—} |

(3) Jane
What is my favorite number?

| | | | |
|---|---|---|---|
| (a) 301, | Goto (5) Nike | Code: | _ _ _ k |
| (b) 101, | Goto (4) Mitch | Code: | _ _ _ i |
| (c) 201, | Goto (1) Deepak | Code: | _ _ _ f |

(4) Mitch
What is going on in my mind

| | | | |
|---|---|---|---|
| (a) Feel like singing loudly; | Goto (2) Barack Obama | Code: | _ _ g _{—} |
| (b) Feel like tricking you; | Goto (3) Jane | Code: | _ _ i _{—} |
| (c) Feel like yelling at you; | Goto (6) Tiger | Code: | _ _ l _{—} |

(5) Nike
Jordan Shoe provides the best performant fit for what sports?

| | | |
|---|---|---|
| (a) Basketball; | Goto (3) Jane | Code: _ k _ _{—} |
| (b) Baseball; | Goto (7) Deepak | Code: _ e _ _{—} |
| (c) Golf; | Goto (6) Tiger | Code: _ j _ _{—} |

(6) Tiger
I currently think God is ..

| | | |
|---|---|---|
| (a) great; | Go to (4) Mitch | Code: _ _ l _{—} |
| (b) non-existent; | Go to (8) Yi Ling | Code: _ _ h _{—} |
| (c) me; | Go to (5) Nike | Code: _ _ j _{—} |

(7) Jack
What is the name of my high school?

| | | |
|---|---|---|
| (a) Sunrise High School; | Goto (5) Nike | Code: _ _ _ e |
| (b) Westview High School; | Goto (1) Deepak | Code: _ _ _ a |
| (c) Sunset High School; | Goto (8) Yi Ling | Code: _ _ _ b |

(8) Yi Ling
What is my paternal granddad's granddad's name?

| | | |
|---|---|---|
| (a) Yi Zhang; | Goto (6) Tiger | Code: h _ _ _{—} |
| (b) Xiao Chao; | Goto (7) Jack | Code: b _ _ _{—} |
| (c) Xie Chen; | Goto (2) Barack Obama | Code: c _ _ _{—} |

As an example, vertex 5 is mapped to question 8, as seen in the mapping of Table 3. This question corresponds to Nike® as seen from Table 2. Hence the question for vertex 5 is “Jordan shoes provide the most performance fit for what sports?” The order of the answer choices may be randomly generated. As seen in Table 4, choice (a) is the correct choice, and hence the correct answer “basketball” is listed there. Since vertex 3 is on the shortest path to the selected face, a suggestion to go to question 3 is provided. Letter ‘k’ corresponding to the edge on the shortest path may also be provided as a suggestion for one of the letters of the secret code. The position of this letter may not matter since the vertex is not lying on the selected face. Hence the position of the letter is randomly chosen. As discussed above, in some embodiments, positions of letters in the secret code may not matter as long as any sequential circular combination of letters ‘f’, ‘d’, ‘g’, and ‘i’ is considered a correct solution of the secret code.

The second choice for this question is one of the wrong answers, ‘baseball’. Because it is a wrong answer, the suggestion to go to question 7 may be provided, which corresponds to a vertex that takes it away from reaching the selected face. Also, letter ‘e’ may be provided as a suggestion for one of the letters of the secret code. The position of ‘e’, in the secret-code, is suggested to be the same as that suggested for the correct choice, just to keep the position consistent across all the answers for that question.

The third choice for this question is one of the wrong answers ‘Golf’. Because it is a wrong answer, the suggestion to go to question 6 may be provided, which corresponds to a vertex that takes it away from reaching the selected face. Also, letter ‘j’ may be provided as a suggestion for one of the letters of the secret code. The position of ‘j’ is suggested to be the same as that of all the other choices, just to keep the position consistent across all the answers for that question.

As yet another example, vertex 2 is mapped to question 7 as shown in Table 3. Question 7 corresponds to ‘Barack Obama’ as shown in Table 2. Hence the question for vertex 2 is “My birthday is?” The order of the answer choices may be randomly generated. In this case the choice (b) is the correct choice, and hence “Aug 4th” is listed there. Because vertex 2 is on the selected face and vertex 4 is the next vertex on the selected face, a suggestion to go to question 4 may be provided. Letter ‘g’ may be suggested as one of the letters of the secret code. The position of this letter does matter because the vertex is lying on the selected face.

The choice (a) is the wrong choice and hence one of the wrong answers “Sept 4th” is listed there. Because vertex 1 is in the wrong direction of the selected loop, a suggestion to go question 1 may be provided. Also, a wrong suggestion of letter ‘d’ for the secret code may be provided. The position of this alphabet may be the same as that of the correct choice, to keep it consistent across all the answers for that question.

The choice (c) is the wrong choice as-well and hence the wrong answer “Oct 4th” is listed. Because vertex 8 is in a wrong direction a suggestion to go to question 8 may be provided. Also, a wrong suggestion of letter ‘c’ for the secret code may be provided. The position of this letter may be the same as that of the correct choice, to keep it consistent across all the answers for that question.

In summary, the challenge generated as described above may provide necessary clues to encourage participant users to communicate with each other in order to find a solution to the secret code. Accordingly, the users may be motivated to form collaborations with other users and communicate with the other users in a timely and dynamic fashion.

As described in reference to FIG. 1, challenge output module 124 may output the challenge generated by the challenge generation logic 122 as shown in Table 4, and present the challenge to each participant user (e.g., via the user interface 128). In some embodiments, every participant may receive a set of suggestions corresponding to that participant. For example, referring to Table 4, Deepak may only receive the questions, answers, and suggestions corresponding to Deepak (vertex 1), Jane may only receive the questions, answers, and suggestions corresponding Jane (vertex 3), and so on.

Having the challenge provided to them, the participant users may be challenged to find the secret code using the information they know and the information they derive from other participants. For example, when a participant user determines the correct answer for a given question as presented in Table 4, the participant may then use the suggested letter as one of the letters of the secret code. In some instances, the position of the letter (if suggested) may be used to place the letter in the correct position of the secret code.

The participant user may then go to the suggested question to solve. As the participant user starts looping around the same set of questions, after having determined the answers for the corresponding question, the participant user may discern the secret code and present it to the organizer (e.g., via the user input module 116). The first participant that figures out the secret code may be considered the winner.

As an example, Tiger knows the answer to question (6) is the choice (a). Tiger may note ‘1’ as the third letter of the secret code. Tiger may go to Mitch as suggested by his challenge (see Table 4), converse with Mitch (e.g., over the user input module 116) and determine that (b) is the correct answer. Tiger this time may note that ‘i’ is the third letter of the secret-code.

Tiger may then communicate with Jane (as suggested by Table 4) and use his negotiation skills to determine that (c) is the correct choice. Tiger may note ‘f’ as the fourth letter of the secret code and initiate communication with Deepak to determine that (b) is the correct answer. Tiger may note ‘d’ as the first letter of the secret code and head to “Barack Obama.”

Tiger may know that “Barack Obama” is not present in the competition. Tiger may use his general knowledge to determine that (b) is the correct choice. Tiger may note ‘g’ as the second letter of the secret code and communicate with Mitch. But Tiger has already communicated with Mitch. Tiger may conclude that he has solved the secret-code, which is ‘dgif’.

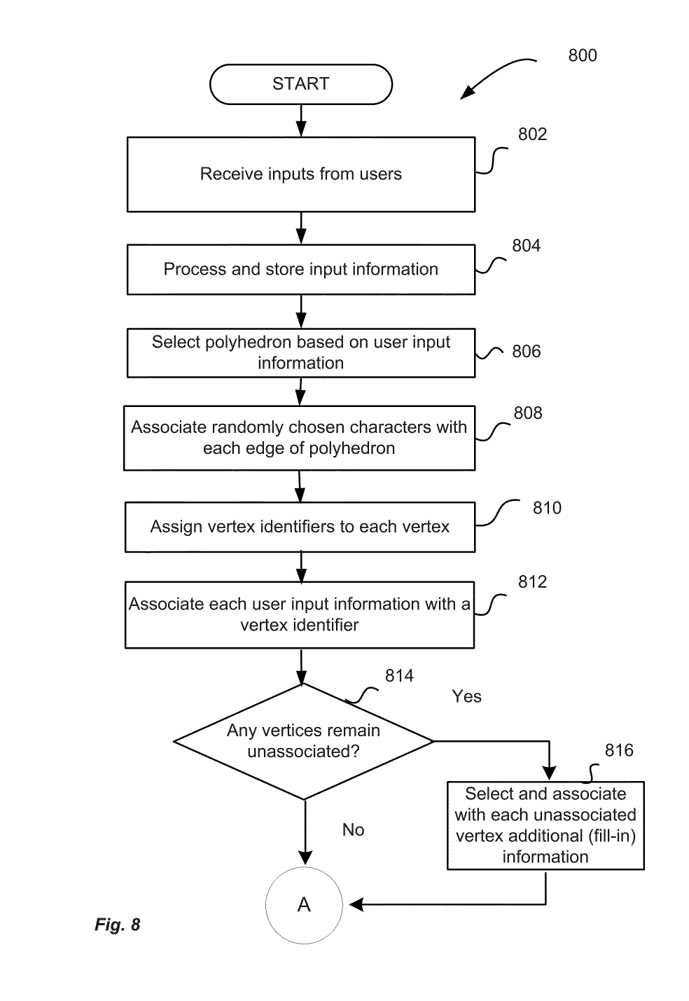

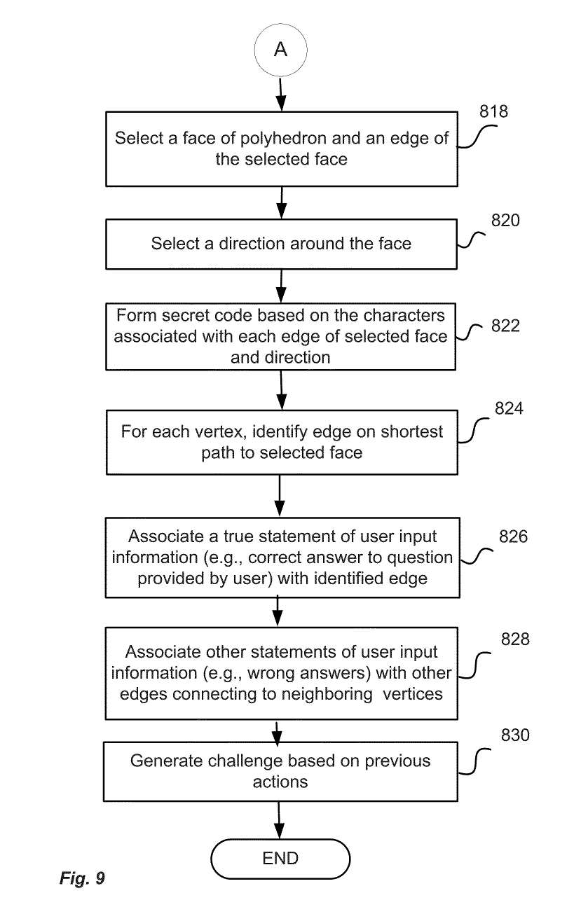

FIGS. 8-9 illustrate an example process 800 for facilitating competitive collaboration, in accordance with some embodiments. The process 800 may be performed, for example, by the system 100 configured as described in reference to FIG. 1. It will be appreciated that the order of description may not be construed as to imply that the operations of the process 800 described below are necessarily order dependent. In particular, these operations may not be performed in the order of presentation. At least some or all of the operations of process 800 may be performed in a different order than the described embodiment, as will be evident from the description below.

The process 800 may begin at block 802, where the system 100 may receive input information from participant users. The input information may comprise a number of statements, one of which may be true and others may be false. As described in reference to FIGS. 2-7, the statements may include a question and a plurality of answers to the question, one of which may be a true statement.

At block 804, the system 100 may process and store user input information. In some embodiments, a number of participant users may comprise two or more users.

For example, user input information may be collected from participant users, aggregated, and stored for further processing. The user input information may be associated with a user unique identifier (e.g., user name or nickname), and a unique identifier (e.g., a particular number) may be assigned to the user-input information. As a result, the user-input information may include a plurality of user-associated data portions (e.g., a list of data portions), each portion having a unique identifier (e.g., a number) assigned to the portion. As shown in Table 1, Jack and associated user-input information may be assigned number 1, Jane may be assigned number 2, Mitch may be assigned number 3, and so on.

At block 806, the system 100 may select a polyhedron based on user-input information. The polyhedron may be selected such that the number of vertices may be equal or greater than the number participant users that provided user input information.

At block 808, the computer system 100 may associate characters (e.g., letter of alphabet with each edge of the selected polyhedron. In some embodiments, the characters may be randomly chosen.

At block 810, the system 100 may assign unique identifiers to each vertex of the polyhedron. In some embodiments, the unique identifiers may comprise numbers. The unique identifiers may be assigned in a random fashion.

At block 812, the system 100 may associate each participant user (e.g., each user-input information portion) with a vertex identifier. As shown in Table 3, Jack and associated user-input information may be assigned to vertex 7, Jane and associated user-input information may be assigned to vertex 3, Mitch and associated user-input information may be assigned to vertex 4, and so on.

At decision block 814, a determination may be made whether there are vertices that remain unassociated, e.g., when the number of vertices in the selected polyhedron is greater than the number of participant users. If it is determined that the number of vertices in the selected polyhedron is greater than the number of participant users, at block 816 each unassociated vertex may be associated with additional (fill-in) information portion. The information portions (e.g., shown in Table 2) may be pre-stored and retrieved from a data store, for example. In some embodiments, information portions may be obtained dynamically from affiliated services, for example, advertisement service or other commercial entity.

At block 818, the system 100 may select (e.g., randomly) a face of the polyhedron for a provision of a secret code.

At block 820, the system 100 may select (e.g. randomly) a direction of looping around the selected face.

At block 822, the system 100 may form a secret code. The secret code may comprise a sequence of characters associated with edges of the selected face, wherein the order of the characters in a code may correspond to a direction of a loop around the selected face.

At block 824, the system 100 may identify a shortest path to the selected face and an edge on a shortest path to the selected face, for each vertex of the polyhedron.

At block 826, the system 100 may, for each user-input information portion, associate a true statement of the user-input information associated with the selected vertex (e.g., a correct answer to the question) with the identified edge that lies on the shortest past to the selected face.

At block 828, the system 100 may associate other statements (e.g., false statements such as wrong answers to the question) with the edges connecting all the other neighboring vertices with the selected vertex. If a neighboring vertex belongs to (lies on) the selected face that corresponds to the secret code, the true statement (e.g., correct answer to the question) may be associated with the edge leading to the next vertex in the selected direction of looping the selected face.

At block 830, the system 100 may generate challenges for the participant users. Each challenge may include suggestions for the characters comprising the secret code, wherein the suggestions include those characters that are associated with edges that correspond to a true statement and false statements associated with other edges extending from the selected vertex and connecting the vertex with neighboring vertices. As shown in Table 4, the challenge may also include suggestions to contact other participant users associated with neighboring vertices.

FIG. 10 illustrates an example computing device 1000 suitable for use to practice all or selected aspects of the present disclosure, in accordance with various embodiments. In some embodiments, the computing device 1000 may be configured as a special purpose computing device, i.e. a computing device configured solely for the purpose of facilitating competitive collaboration, and not for general purpose computing, such as processor based devices configured for use as set-top box, game console, smartphones, e-book, tablets for consuming audio/video contents, and so forth. In some embodiments, the computing device 1000 may be configured as a general purpose computing device, with facilities configured to execute virtually any binaries (subject only to computing cycles, and/or memory/storage constraints).

As shown, computing device 1000 may include one or more processors or processor cores 1002, and system memory 1004. For the purpose of this application, including the claims, the terms “processor” and “processor cores” may be considered synonymous, unless the context clearly requires otherwise. The processor 1002 may include any type of processors, such as a central processing unit (CPU), a microprocessor, and the like. The processor 1002 may be implemented as an integrated circuit having multi-cores, e.g., a multi-core microprocessor.

The computing device 1000 may include mass storage devices 1006, such as volatile memory (e.g., DRAM). In some embodiments, the mass storage devices 1006 may include a hard drive, compact disc read only memory (CD-ROM), digital versatile disk (DVD) and so forth. In general, system memory 1004 and/or mass storage devices 1006 may be temporal and/or persistent storage of any type, including, but not limited to, volatile and non-volatile memory, optical, magnetic, and/or solid state mass storage, and so forth.

The computing device 1000 may further include input/output (I/O) devices 1008 such as a display, keyboard, cursor control, remote control, gaming controller, image capture device, and so forth, and communication interfaces (comm. INTF) 1010 (such as network interface cards, modems, infrared receivers, radio receivers (e.g., Bluetooth), and so forth).

The communication interfaces 1010 may include communication chips (not shown) that may be configured to operate the device 1000 (or 100) in accordance with a Global System for Mobile Communication (GSM), Long-Term Evolution (LTE) network, near-field, Wi-Fi, or other communication protocols known in the art.

The above-described computing device 1000 elements may be coupled to each other via system bus 1012, which may represent one or more buses. In the case of multiple buses, they may be bridged by one or more bus bridges (not shown). Each of these elements may perform its conventional functions known in the art. In particular, system memory 1004 and mass storage devices 1006 may be employed to store a working copy and a permanent copy of the programming instructions implementing the operations associated with ystem 100, e.g., operations associated with the include a plurality of logic and functional modules 116, 118, 120, 122, and 124, as described in reference to FIGS. 1-9. The various elements may be implemented by assembler instructions supported by processor(s) 1002 or high-level languages that may be compiled into such instructions.

The permanent copy of the programming instructions may be placed into mass storage devices 1006 in the factory, or in the field, through, for example, a distribution medium (not shown), such as a compact disc (CD), or through communication interfaces 1010 (from a distribution server (not shown)).

The number, capability and/or capacity of the elements 1008, 1010, or 1012 may vary, depending on whether computing device 1000 is used as a stationary computing device, such as a set-top box or desktop computer, or a mobile computing device, such as a tablet computing device, laptop computer, game console, or smartphone. Their constitutions are otherwise known, and accordingly will not be further described.

In embodiments, at least one of processors 1002 may be packaged together with memory having computational logic 1022 configured to practice aspects of embodiments described in reference to FIGS. 1-9. For one embodiment, at least one of the processors 1002 may be packaged together with memory having computational logic 1022 configured to practice aspects of process 800 of FIGS. 8-9 to form an integrated circuit, such as a System in Package (SiP), a System on Chip (SoC) or ASIC, or a programmed programmable device (such as Field Programmable Gate Arrays (FPGA)). In various implementations, the computing device 1000 may comprise a non-general purpose computing device, such as, for example, a smartphone, a personal digital assistant (PDA), a tablet computer, a set-top box, a game console, or an e-book.

In some implementations, the computing device 1000 may comprise a general purpose computing device, such as a laptop, a netbook, a notebook, an ultrabook, a desktop computer, or a server. In further implementations, the computing device 1000 may be any other electronic device that processes data.

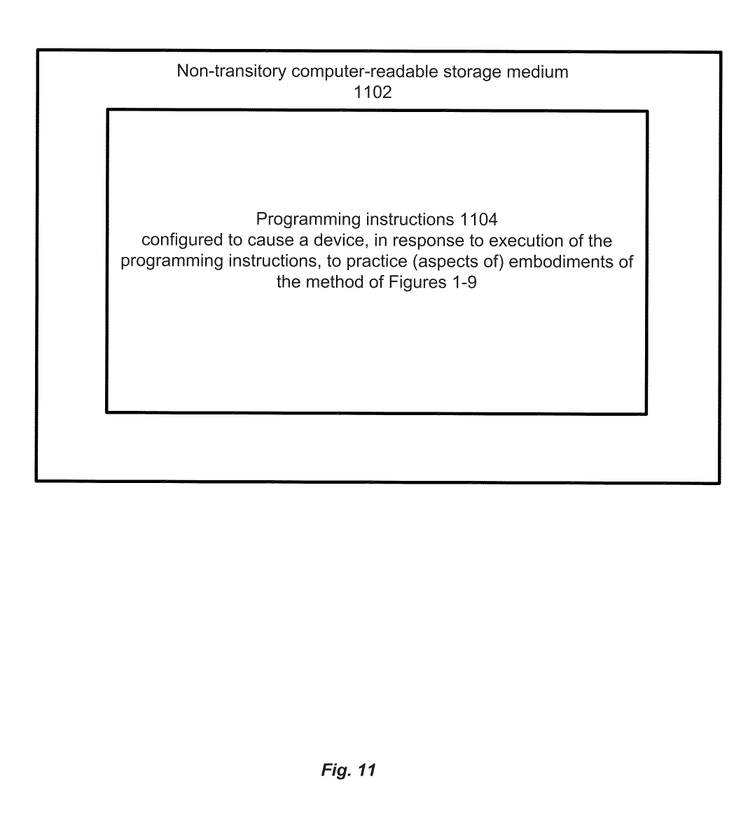

FIG. 11 illustrates an example computer-readable storage medium 1102 having instructions configured to cause a processor-based device to practice all or selected aspects of the present disclosure, in accordance with various embodiments. As illustrated, computer-readable storage medium 1102 may include a number of programming instructions 1104. Programming instructions 1104 may be configured to enable a device, e.g., computing device 1000, in response to execution of the programming instructions, to perform, e.g., various operations of processes of FIGS. 1-9, e.g., but not limited to, to the various operations performed to perform determination of frame alignments. In some embodiments, programming instructions 1104 may be used to program a special purpose computing device, an ASIC or a programmable integrated circuit, as described in reference to FIG. 10. In some embodiments, programming instructions 1104 may be used to program a special purpose computing device as also described in reference to FIG. 10. In some embodiments, programming instructions 1104 may be disposed on multiple computer-readable storage media 1102.

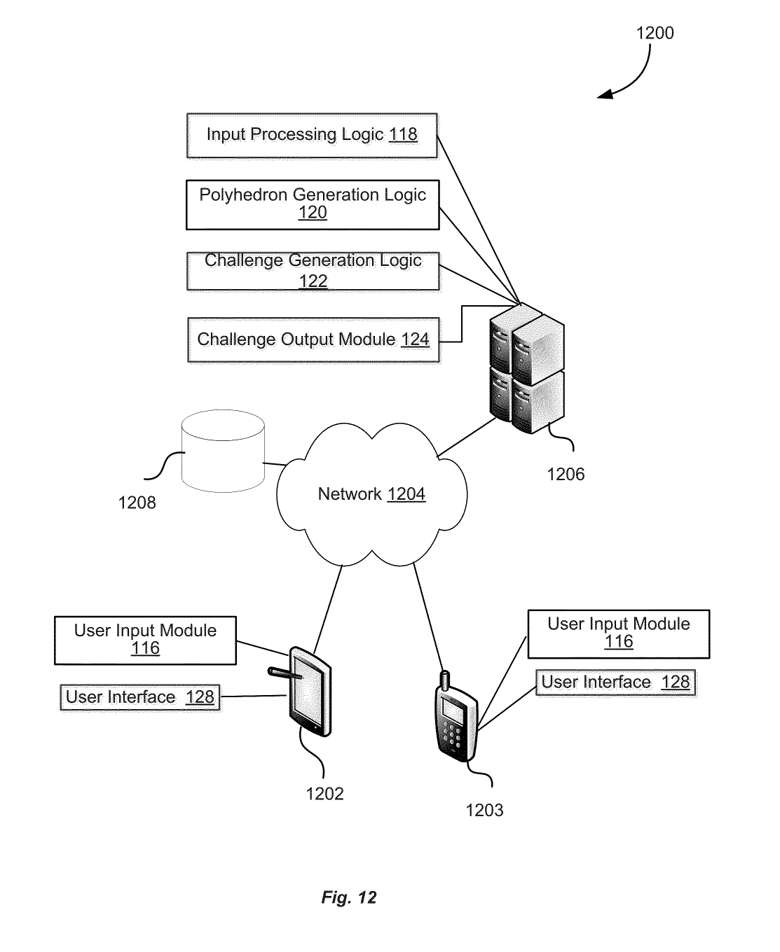

FIG. 12 is an example computing environment 1200 suitable for practicing all or selected aspects of the present disclosure, in accordance with some embodiments. The environment 1200 may be realized utilizing one or more of the embodiments described above in connection with FIGS. 1 and 10-11.

The environment 1200 may include a plurality of client computing devices, e.g., 1202 and 1203. The client computing devices 1202, 1203 may utilize a network 1204 to communicate with an application server 1206 that may be configured to facilitate competitive collaboration as described in reference to FIGS. 1-9. As discussed in reference to FIG. 10, examples of client devices 1202, 1203 may include special purpose competitive collaboration devices, cell phones, handheld messaging devices, set-top boxes, personal data assistants, electronic book readers, and the like. In alternate embodiments, one or more of client devices 1202 and 1203 may be a general purpose computing device, such as a laptop, or a desktop.

Network 1204 may include Internet, mobile network, intranet, a local area network (e.g., near field or Wi-Fi), and generally any suitable communications network. Protocols and components for communicating via such a network are well known and will not be discussed herein in detail. Communication over the network 1204 may be enabled by wired or wireless connections, and combinations thereof.

The environment may include an application server 1206 and a data store 1208. It should be understood that there can be several application servers, layers, or other elements, processes, or components, which may be chained or otherwise configured, which can interact to perform tasks such as obtaining data from an appropriate data store. As used herein, the term “data store” refers to any device or combination of devices capable of storing, accessing, and retrieving data, which may include any combination and number of data servers, databases, data storage devices, and data storage media, in any standard, distributed, or clustered environment.

The application server 1206 may include any appropriate hardware and software for integrating with the data store as needed to execute aspects of one or more applications for the client device, handling a majority of the data access and business logic for an application. The application server 1206 may provide some or all functionalities related to generation of the user challenge, as provided by include a plurality of logic and functional modules 116, 118, 120, 122, and 124, as described in reference to FIG. 1.

For example, the application server 1206 may include (e.g., execute) input processing logic 118, polyhedron generation logic 120, challenge generation logic 122, and challenge output module 124, as shown in FIG. 12. The application server 1206 may provide user input module 116 (e.g., including user interface 128) for execution on client devices 1202, 1203. User-input information as provided by the participant users via the user interface 128 may be processed by the application server 1206 and stored in the data store 1208 that may be accessible by the application server 1206.

It will be appreciated that the above distribution of logic and functional modules 116, 118, 120, 122, and 124 among the environment 1200 is provided for illustration purposes only and is not limiting the described embodiments. Different other ways of distribution of functionalities related to logic and functional modules 116, 118, 120, 122, and 124 in the environment 1200 may be contemplated. For example, input processing logic 118 and/or challenge output module 124 may be disposed on client devices 1202 and 1203 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

What is claimed is:

1. An apparatus for user challenge generation, comprising:
an integrated circuit; and
logic to be endowed in or operated by the integrated circuit to:
select an n-polytope having a number of vertices that substantially corresponds to a number of users comprising at least first and second users, having first and second user-associated information, wherein the first and second user information includes respectively first and second true statements and at least first and second false statements;
associate each edge of the n-polytope with a character of a set of characters;
select a face of the n-polytope for a provision of a secret code, the secret code comprising a sequence of characters associated with edges of the selected face, wherein the order of the characters in a code corresponds to a direction of a loop around the selected face;
associate the first user information with a first vertex and the second user information with a second vertex, wherein to associate includes to associate the first and second true statements with first and second edges that correspond to shortest paths from the first and second vertices to the selected face and to associate first and second false statements with at least some of remaining edges connecting the first and second vertices respectively to neighboring vertices; and
generate first and second challenges for the first and second users, wherein the first and second challenges include suggestions for the characters comprising the secret code, wherein the suggestions include those characters that are associated with edges that correspond to first and second true statements and first and second false statements.

2. The apparatus of claim 1, wherein the logic is further to:
receive input comprising the first and second user information.

3. The apparatus of claim 2, wherein each of the first and second user information includes a total number of statements that corresponds to a number of edges extending from a vertex of the selected n-polytope.

4. The apparatus of claim 3, wherein to associate the first user information with a first vertex and the second user information with a second vertex further includes to:
associate, for each of the first and second user information, those statements in the total number of statements that remain after the association of the first and second true statements with the first and second edges and the association of the first and second false statements with at least some of remaining edges connecting the first and second vertices respectively to neighboring vertices, with other remaining edges connecting the first and second vertices to remaining neighboring vertices.

5. The apparatus of claim 1, wherein to select a n-polytope having a number of vertices that substantially corresponds to a number of participant users includes to select the n-polytope with the number that is equal to or greater than the number of participant users.

6. The apparatus of claim 1, wherein to associate each edge of the n-polytope with a character includes to randomly associate each edge with the character, wherein the set of characters comprises letters of alphabet.

7. The apparatus of claim 1, wherein the logic is further to:
determine a first number of remaining vertices after the association of the first user information with a first vertex and the second user information with a second vertex;
obtain a second number of portions of information corresponding to the first number; and
associate each remaining vertex with a portion of information included in the second number of portions.

8. The apparatus of claim 1, wherein to associate the first user information with a first vertex and the second user information with a second vertex includes to:
assign vertex identifiers to each vertex; and
associate the first user information with a first identifier of the first vertex and the second user information with a second identifier of the second vertex.

9. The apparatus of claim 1, wherein the users comprise a plurality of users each having associated user information, wherein the first and second challenges further include suggestions to contact users associated with vertices that are connected to the first and second vertices respectively.

10. The apparatus of claim 1, wherein the integrated circuit is a microprocessor, and the apparatus comprises one of a non-general purpose computing device, a smartphone, a tablet computer, a set-top box, a game console, or an e-book.

11. The apparatus of claim 1, wherein the integrated circuit is an application specific integrated circuit (ASIC) or a programmable integrated circuit, endowed with the logic.

12. The apparatus of claim 1, wherein the apparatus is not configured for general purpose computing.

13. The apparatus of claim 1, wherein one of the first or second users comprises an electronic entity, wherein the entity is to provide the first or second user information, or the first and second user information.

14. The apparatus of claim 1, wherein the n-polytope comprises a polyhedron.

15. A computer-implemented method for user challenge generation, comprising:
selecting, by a computing device, a n-polytope having a number of vertices that substantially corresponds to a number of users comprising at least first and second users, having first and second user-associated information, the first and second user information including respectively first and second true statements and at least first and second false statements;
associating, by the computing device, each edge of the n-polytope with a character of a set of characters;
selecting, by the computing device, a face of the n-polytope for a provision of a secret code, the secret code comprising a sequence of characters associated with edges of the selected face, wherein the order of the characters in a code corresponds to a direction of a loop around the selected face;
associating, by the computing device, the first user information with a first vertex and the second user information with a second vertex, wherein to associate includes to associate the first and second true statements with first and second edges that correspond to shortest paths from the first and second vertices to the selected face and to associate first and second false statements with at least some of remaining edges connecting the first and second vertices respectively to neighboring vertices; and
generating, by the computing device, first and second challenges for the first and second users, wherein the first and second challenges include suggestions for the characters comprising the secret code, wherein the suggestions include those characters that are associated with edges that correspond to first and second true statements and first and second false statements.

16. The computer-implemented method of claim 15, further comprising:
receiving, by the computing device, input comprising the first and second user information.

17. The computer-implemented method of claim 15, wherein each of the first and second user information includes a total number of statements that corresponds to a number of edges extending from a vertex of the selected n-polytope, wherein the method further comprises:
associating, by the computing device, for each of the first and second user information, those statements in the total number of statements that remain after associating the first and second true statements with the first and second edges and after associating the first and second false statements with at least some of remaining edges connecting the first and second vertices respectively to neighboring vertices, with other remaining edges connecting the first and second vertices to remaining neighboring vertices.

18. The computer-implemented method of claim 15, wherein selecting a n-polytope having a number of vertices that substantially corresponds to a number of participant users includes:
selecting, by the computing device, the n-polytope with the number of vertices that is equal to or greater than the number of participant users.

19. The computer-implemented method of claim 15, wherein associating each edge of the n-polytope with a character includes:
randomly associating, by the computing device, each edge with the character, wherein the set of characters comprises letters of alphabet.

20. The computer-implemented method of claim 15, further comprising:
determining, by the computing device, a first number of remaining vertices after associating the first user information with a first vertex and the second user information with a second vertex;
obtaining, by the computing device, a second number of portions of information corresponding to the first number; and
associating, by the computing device, each remaining vertex with a portion of information included in the second number of portions.

21. At least one non-transitory computer-readable medium comprising executable instructions that, in response to execution of the instructions by an apparatus, cause the apparatus to generate a challenge for users, which includes the apparatus caused to:
select a n-polytope having a number of vertices that substantially corresponds to a number of users comprising at least first and second users, having first and second user-associated information, wherein the first and second user information includes respectively first and second true statements and at least first and second false statements;
associate each edge of the n-polytope with a character of a set of characters;
select a face of the n-polytope for a provision of a secret code, the secret code comprising a sequence of characters associated with edges of the selected face, wherein the order of the characters in a code corresponds to a direction of a loop around the selected face;
associate the first user information with a first vertex and the second user information with a second vertex, wherein to associate includes to associate the first and second true statements with first and second edges that correspond to shortest paths from the first and second vertices to the selected face and to associate first and second false statements with at least some of remaining edges connecting the first and second vertices respectively to neighboring vertices; and
generate first and second challenges for the first and second users, wherein the first and second challenges include suggestions for the characters comprising the secret code, wherein the suggestions include those characters that are associated with edges that correspond to first and second true statements and first and second false statements.

22. The at least one non-transitory computer-readable medium of claim 21, wherein the apparatus is not configured for general purpose computing.

23. The at least one non-transitory computer-readable medium of claim 21, wherein each of the first and second user information includes a total number of statements that corresponds to a number of edges extending from a vertex of the selected n-polytope, wherein to associate the first user information with a first vertex and the second user information with a second vertex further includes to:
associate, for each of the first and second user information, those statements in the total number of statements that remain after the association of the first and second true statements with the first and second edges and the association of the first and second false statements with at least some of remaining edges connecting the first and second vertices respectively to neighboring vertices, with other remaining edges connecting the first and second vertices to remaining neighboring vertices.

24. The at least one non-transitory computer-readable medium of claim 21, wherein the apparatus is further caused to:
determine a first number of remaining vertices after the association of the first user information with a first vertex and the second user information with a second vertex;
obtain a second number of portions of information corresponding to the first number; and
associate each remaining vertex with a portion of information included in the second number of portions.

25. The at least one non-transitory computer-readable medium of claim 21, wherein to associate the first user information with a first vertex and the second user information with a second vertex includes to:
assign vertex identifiers to each vertex; and
associate the first user information with a first identifier of the first vertex and the second user information with a second identifier of the second vertex.
